(19) United States
(12) Patent Application Publication
(10) Pub. No.: US 2010/0042662 A1
(43) Pub. Date: Feb. 18, 2010

(54) SYSTEM AND METHOD FOR BACKING UP A PHONEBOOK IN AN ELECTRONIC DEVICE

(75) Inventor: HUA-JEN MAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/479,828

(22) Filed: Jun. 7, 2009

(30) Foreign Application Priority Data
Aug. 15, 2008 (CN) 200810303846.7

(51) Int. Cl. G06F 12/16; G06F 12/00; G06F 15/16; G06F 17/30

(52) U.S. Cl. 707/204; 709/206; 707/10; 707/E17.01; 707/E17.032; 711/E12.001; 711/E12.103

(57) ABSTRACT

A system and method for backing up a phonebook in an electronic device creates a backup file, copies data in the phonebook to the backup file, and sets an identification for the backup file. The system and method further attaches the backup file to an multimedia service (MMS) message, adds the identification to a title of the MMS message, and sends the MMS message attached with the backup file to a target electronic devices. The target electronic devices determines if a title of any received MMS message contains the identification of the backup file, detaches the backup file from the MMS message and copies data in the backup file to a phonebook of the target electronic devices, in response to a determination that the received MMS message contains the identification of the backup file.

### BACKGROUND

1. Technical Field

Embodiments of the present disclosure are related to file backup systems and methods, and particularly to a system and method for backing up a phonebook in electronic devices.

2. Description of Related Art

With high-speed development of software and hardware, replacement of electronic devices becomes common in people's life. For example, business men may have more than one mobile phone, and young people like to replace their old mobile phones with newly launched mobile phones. In such situations, people may desire to copy contact information in a phonebook of one mobile phone to another mobile phone. At present, two methods can be adopted, one method is to copy every contact entry in the phonebook from a memory of the mobile phone to a subscriber identification module (SIM) card, insert the SIM card to the another mobile phone, and copy every contact entry from the SIM card to a memory of the another mobile phone. Another method is to transfer data in the phone book to a computer via a data cable, and download the data to the another mobile phone from the computer. The former method needs to remove the SIM card frequently, and the later method depends on the computer.

### BRIEF DESCRIPTION OF THE DRAWINGS

FIG. 1 is a block diagram of one embodiment of an electronic device comprising a phone book backup system.

FIG. 2 is a flowchart of one embodiment of a method for backing up a phonebook in an electronic device.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

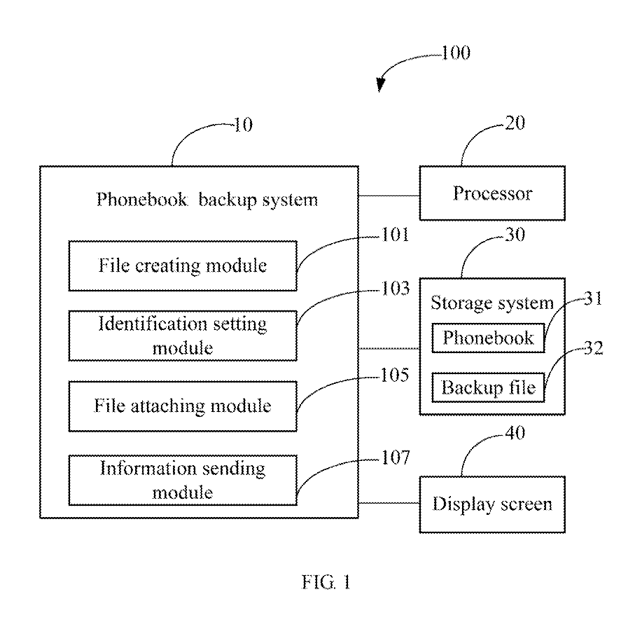

FIG. 1 is a block diagram of one embodiment of an electronic device 100 comprising a phonebook backup system 10. The electronic device 100 may include at least one processor 20, a storage system 30, and a display screen 40. The at least one processor 20 executes computerized codes for the phonebook backup system 10, to back up a phonebook 31 of the electronic device 100. In one embodiment, the phonebook backup system 10 is included in the storage device 30 or a computer readable medium of the electronic device 100. Depending on the embodiment, the electronic device 100 may be a mobile phone or a personal digital assistant. In another embodiment, the phonebook backup system 10 may be included in an operating system of the electronic device 100.

The storage system 30 stores the phonebook 31 and a plurality of multimedia service (MMS) messages. Files, such as electronic business cards, electronic calendars, etc., can be send to a target electronic device (not shown) as MMS message attachments, and be stored in the target electronic device after being detached from the MMS messages. In one embodiment, the storage system 30 may be a smart media card, a secure digital card, a compact flash card, a multimedia card, or an extreme digital card, for example. The target electronic device may also be a mobile phone or a personal digital assistant.

The display screen 40 displays data of the phonebook 31 to a user of the electronic device 100, such as a contact name, a contact phone number, a contact address, and so on, in each contact entry of the phonebook. The display screen 40 also displays the MMS messages to the user.

In one embodiment, the phonebook backup system 10 includes a file creating module 101, an identification setting module 103, a file attaching module 105, and an information sending module 107. Each of the modules 101-107 can be executed by the at least one processor 20 of the electronic device 100.

The file creating module 101 is operable to create a backup file 32 for the phonebook 31 of the electronic device 100, copy data in the phonebook 31 to the backup file 32, and store the backup file 32 in the storage system 30.

The identification setting module 103 is operable to set an identification for the backup file 32 of the phonebook 31, so as to distinguish the backup file 32 from other files. The identification may be a character, a numerical number, or a combination of characters or numbers. For example, the identification setting module 103 may set the term “contact” consisting of seven characters as the identification of the backup file 32.

The file attaching module 105 is operable to attach the backup file 32 to an MMS message selected from the storage system 30 by a user of the electronic device 100, and add the identification of the backup file 32 to a title of the MMS.

The information sending module 107 is operable to send the MMS message attached with the backup file 32 of the phonebook 31 to the target electronic device via a network, such as a global system for mobile communication (GSM) network. For example, the user of the electronic device 100 may want to copy data in the phonebook 31 of the electronic device 100 to one of his other electronic devices, i.e. the target electronic device. After receiving the MMS message, the target electronic device determines if the MMS message contains the backup file 32 by determining if the title of the MMS message contains the preset identification, such as the identification “contact.” It may be understood that, the target electronic device may also include the identification module 103, so that the target electronic device can identify the identification of the backup file 32. If the MMS message contains the backup file 32 of the phonebook 31 of the electronic device 100, the target electronic device detaches the backup file 32 from the MMS message and stores data in the backup file 32 to its memory. It may be understood that the MMS message may be received from the electronic device 100 along with any number of electronic devices in communication via the network.

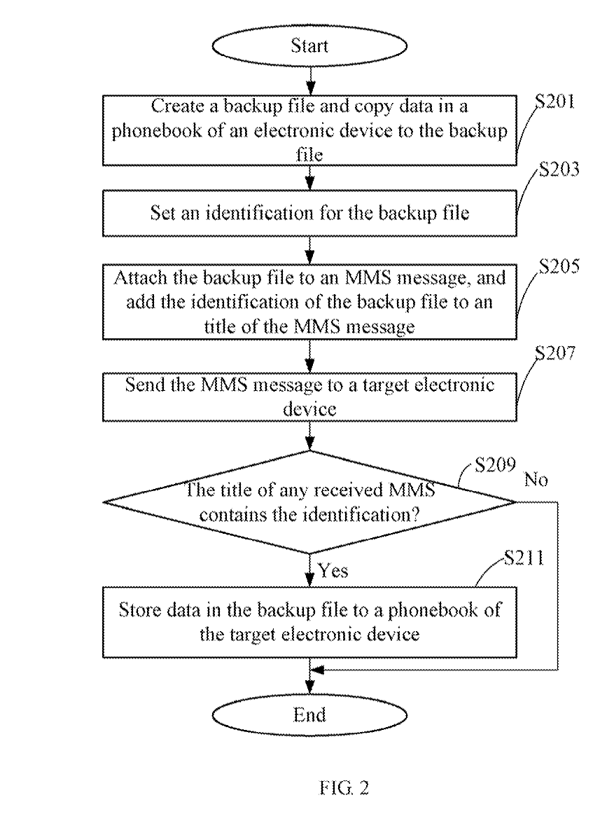

FIG. 2 is a flowchart of one embodiment of a method for backing up a phonebook 31 of the electronic device 100 in FIG. 1. Depending on the embodiment, additional blocks may be added, others removed, and the ordering of the blocks may be changed.

In block S201, the file creating module 101 creates a backup file 32 for the phonebook 31 of the electronic device 100, copies data in the phonebook 31 to the backup file 32, and stores the backup file 32 in the storage system 30.

In block S203, the identification setting module 103 sets an identification for the backup file 32 of the phonebook 31, so as to distinguish the backup file 32 from other files. In this embodiment, the identification setting module 103 sets “contact” as the identification of the backup file 32. In other embodiments, the identification may be set as a character, a numerical number, or a combination of numbers.

In block S205, the file attaching module 105 attaches the backup file 32 to an MMS message selected from the storage system 30 by the user of the electronic device 100, and adds the identification of the backup file 32 to a title of the MMS message. For example, the file attaching module 105 adds the identification “contact” to the title of the MMS message.

In block S207, the information sending module 107 sends the MMS message attached with the backup file 32 of the phonebook 31 to the target electronic device, e.g., another mobile phone or personal digital assistant of the user, via a network, such as a global system for mobile communication (GSM) network.

In block S209, when receiving the MMS message, the target electronic device determines if the title of the received MMS contains the identification of the backup file 32. As mentioned above, the target electronic device may also include the identification module 103, so that the target electronic device can identify the identification of the backup file 32. If the title of the received MMS message does not contain the identification of the backup file 32, the target electronic device determines the received MMS message as a common MMS message, the procedure ends. Otherwise, if the title of the received MMS message contains the identification of the backup file 32, the procedure goes to block S211.

In block S211, the target electronic device detaches the backup file 32 from the received MMS, and stores the data in the backup file 32 to the target electronic device 100, then the user of the target electronic device can further arrange contact information from the data in the backup file 32.

The above embodiments utilize MMS messages as carriers to send data in a phonebook of an electronic device to another electronic device, so that contact information stored in one mobile phone can be transferred to other mobile phones independent of SIM cards and computers.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device for backing up a phonebook, the electronic device comprising:
at least one processor;
a storage system; and
one or more programs stored in the storage system and being executed by the at least one processor, the one or more programs comprising:
a file creating module to create a backup file for the phonebook, copy data in the phonebook to the backup file, and store the backup file in the storage system;
an identification setting module to set an identification for the backup file of the phonebook;
a file attaching module to attach the backup file to an multimedia service message selected from the storage system of the electronic device, and add the identification of the backup file to a title of the multimedia service message; and
an information sending module to send the multimedia service message attached with the backup file to a target electronic device via a network.

2. The electronic device as claimed in claim 1, wherein the electronic device and the target electronic device are mobile phones or personal digital assistants.

3. The electronic device as claimed in claim 1, wherein the storage system is selected from the group consisting of a smart media card, a secure digital card, a compact flash card, a multimedia card, and an extreme digital card.

4. The electronic device as claimed in claim 1, wherein the identification of the backup file is selected from the group consisting of a character, a numerical number, or a combination of characters and numerical numbers.

5. A method for backing up a phonebook in an electronic device, the method comprising:
creating a backup file for the phonebook, copying data in the phonebook to the backup file, and storing the backup file in a storage system of the electronic device;
setting an identification for the backup file of the phonebook;
attaching the backup file to an multimedia service message selected from the storage system of the electronic device, and adding the identification of the backup file to a title of the multimedia service message; and
sending the multimedia service message attached with the backup file to a target electronic device via a network.

6. The method as claimed in claim 5, further comprising:
determining if a title of any received multimedia service message contains the identification of the backup file by the target electronic device; and
detaching the attached backup file from the received multimedia service message and copying data in the backup file to the target electronic device, in response to a determination that the title of the received multimedia service message contains the identification of the backup file.

7. The method as claimed in claim 5, wherein the electronic device and the target electronic devices are mobile phones or personal digital assistants.

8. The method as claimed in claim 5, wherein the storage system is selected from the group consisting of a smart media card, a secure digital card, a compact flash card, a multimedia card, and an extreme digital card.

9. The method as claimed in claim 5, wherein the identification of the backup file is selected from the group consisting of a character, a numerical number, or a combination of characters and numerical numbers.

10. A storage medium storing a set of instructions, the set of instructions capable of being executed by a processor to perform a method for backing up a phonebook in an electronic device, the method comprising:
creating a backup file for the phonebook, copying data in the phonebook to the backup file, and storing the backup file in a storage system of the electronic device by a processor;
setting an identification for the backup file of the phonebook;
attaching the backup file to an multimedia service message selected from the storage system of the electronic device, and adding the identification of the backup file to a title of the multimedia service message; and
sending the multimedia service message attached with the backup file to a target electronic devices via a network.

11. The storage medium as claimed in claim 10, wherein the method further comprising:
determining if a title of any received multimedia service message contains the identification of the backup file by the target electronic devices; and
detaching the attached backup file from the received multimedia service message and copying data in the backup file to the target electronic devices, in response to a determination that the title of the received multimedia service message contains the identification of the backup file.

12. The storage medium as claimed in claim 10, wherein the electronic device and the target electronic device are mobile phones or personal digital assistants.

13. The storage medium as claimed in claim 10, wherein the storage system is selected from the group consisting of a smart media card, a secure digital card, a compact flash card, a multimedia card, and an extreme digital card.

14. The storage medium as claimed in claim 10, wherein the identification of the backup file is selected from the group consisting of a character, a numerical number, or a combination of characters and numerical numbers.
